(19) United States
(12) Patent Application Publication
(10) Pub. No.: US 2010/0002038 A1
(43) Pub. Date: Jan. 7, 2010

(54) INKJET PRINTER, PRINTING METHOD AND INK DRYER

(75) Inventors: Yoshiki Onozawa, Tomi-city (JP); Ryuji Yamada, Tomi-city (JP)

Correspondence Address: DITTHAVONG MORI & STEINER, P.C., 918 Prince Street, Alexandria, VA, 22314, US

(73) Assignee: MIMAKI ENGINEERING CO., LTD., Tomi-city (JP)

(21) Appl. No.: 12/497,464

(22) Filed: Jul. 2, 2009

(30) Foreign Application Priority Data
Jul. 7, 2008 (JP) 2008-177184

(51) Int. Cl. B41J 29/38

(52) U.S. Cl. 347/17

(57) ABSTRACT

An inkjet printer includes an inkjet head, a wave guide, an electromagnetic-wave supplier, and a detector. The inkjet head is configured to eject an ink onto a surface of a recording medium. The recording medium onto which the ink has been ejected is to pass through the wave guide. The electromagnetic-wave supplier is configured to supply electromagnetic waves into the wave guide. The detector is configured to detect a parameter relating to a dryness of the recording medium which has passed through the wave guide. The controller is configured to control the electromagnetic-wave supplier to control an intensity of the electromagnetic waves according to the parameter relating to the dryness of the recording medium.

### CROSS-REFERENCE TO RELATED APPLICATIONS

The present application claims priority under 35 U.S.C. §119 to Japanese Patent Application No. 2008-177184, filed Jul. 7, 2008. The contents of this application are incorporated herein by reference in their entirety.

### BACKGROUND OF THE INVENTION

1. Field of the Invention

The present invention relates to an inkjet printer, a printing method, and an ink dryer for the inkjet printer.

2. Discussion of the Background

In an inkjet printer, printing is conducted by ejecting dye-type ink such as acid dye, reactive dye, and substantive dye or pigment-type ink containing organic solvent such as solvent ink, onto a surface or both front and back surfaces of a sheet-like medium (recording medium) made of paper, silk, cotton, vinyl chloride, or the like. Especially in the industrial field, in such an inkjet printer, it is important to effectively dry a medium after deposition of ink onto the medium in order to quickly and easily conduct shipment and delivery after printing.

For example, JP-A-2003-22890 discloses a drying apparatus for drying ink on a medium. The drying apparatus includes a wave guide having a slot, which is configured to allow the medium to move through the slot, and an electromagnetic energy source, which is adapted to establish an electric field within the wave guide such that an angle formed between a direction of the electric field and a longitudinal axis of fibers of the medium becomes greater than ten degrees and less than or equal to ninety degrees.

However, in actual inkjet printer, the printing speed relative to a medium fluctuates. When the printing speed changes, the ejection amount of ink per a unit area of a medium also changes. Accordingly, the medium just after the printing has various drying degrees depending on the locations of the medium. In this case, the drying of the medium may be uneven only by supplying electromagnetic waves of a constant strength into the wave guide through which the medium passes, just like the aforementioned technology.

### SUMMARY OF THE INVENTION

According to one aspect of the present invention, an inkjet printer includes an inkjet head, a wave guide, an electromagnetic-wave supplier, and a detector. The inkjet head is configured to eject an ink onto a surface of a recording medium. The recording medium onto which the ink has been ejected is to pass through the wave guide. The electromagnetic-wave supplier is configured to supply electromagnetic waves into the wave guide. The detector is configured to detect a parameter relating to a dryness of the recording medium which has passed through the wave guide. The controller is configured to control the electromagnetic-wave supplier to control an intensity of the electromagnetic waves according to the parameter relating to the dryness of the recording medium.

According to another aspect of the present invention, an ink dryer for an inkjet printer includes a wave guide, an electromagnetic-wave supplier, a detector, and a controller. A recording medium onto which an ink has been ejected is to pass through the wave guide. The electromagnetic-wave supplier is configured to supply electromagnetic waves into the wave guide. The detector is configured to detect a parameter relating to a dryness of the recording medium which has passed through the wave guide. The controller is configured to control the electromagnetic-wave supplier to control an intensity of the electromagnetic waves according to the parameter relating to the dryness of the recording medium.

According to further aspect of the present invention, a printing method includes ejecting an ink onto a surface of a recording medium. Electromagnetic waves are supplied into a wave guide. The recording medium on which the ink has been ejected is fed into the wave guide. A parameter relating to a dryness of the recording medium which has passed through an inside of the wave guide is detected. An intensity of the electromagnetic waves supplied from the electromagnetic-wave supplier is controlled according to the parameter relating to the dryness of the recording medium.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view showing an inkjet printer according to an embodiment of the present invention;

FIG. 2 is an illustration showing a state of printing and drying of a medium in the inkjet printer according to the embodiment; and

FIG. 3 is a block diagram showing a control system in the inkjet printer according to the embodiment.

### DESCRIPTION OF THE EMBODIMENT

Embodiments will now be described with reference to the accompanying drawings, wherein like reference numerals designate corresponding or identical elements throughout the various drawings.

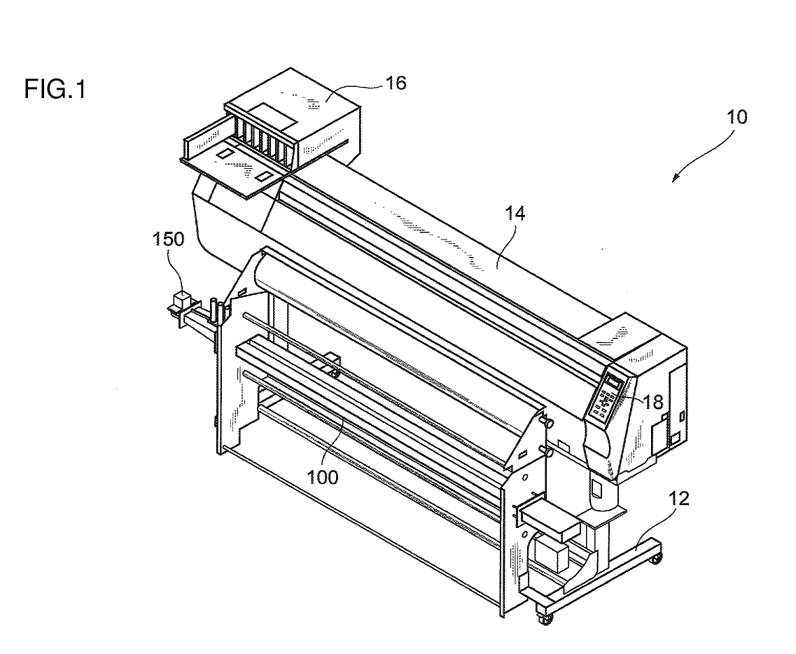

FIG. 1 is a perspective view showing an inkjet printer according to an embodiment of the present invention. As shown in FIG. 1, the inkjet printer 10 of this embodiment includes a printer unit 14 and a wave guide 100 which are mounted on a base 12. The printer unit 14 includes a toner section 16 in which inks of respective kinds to be ejected on a medium are stored and an operation input section 18 by which a user conducts manipulated input. Attached to one end of the wave guide 100 is a magnetron 150 for supplying electromagnetic fields into the wave guide 100.

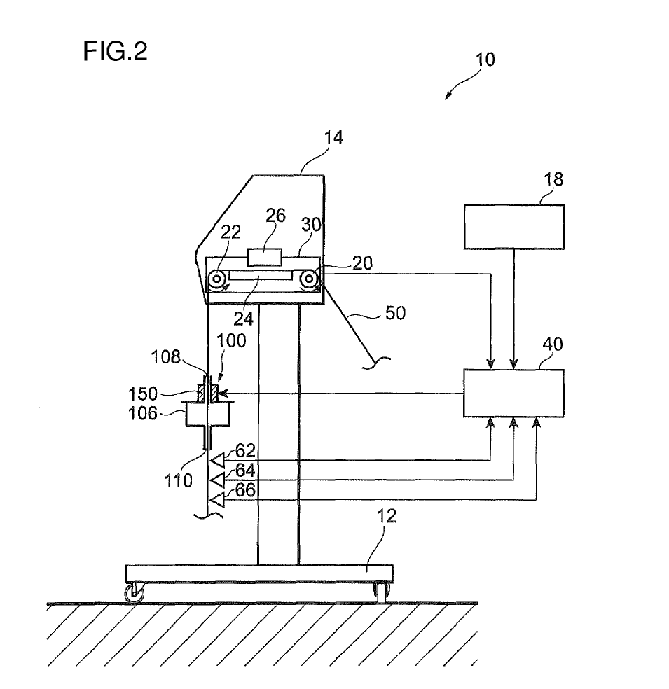

FIG. 2 is an illustration showing a state of printing and drying of a medium in the inkjet printer 10 according to the embodiment. As shown in FIG. 2, in the inkjet printer 10 of this embodiment, a sheet-like medium 5, which is made of paper, silk, cotton, vinyl chloride or the like and is entered into the printer unit 14, is fed by rollers 20, 22 which are driven by a roller driving section 30. The medium 50 fed by the rollers 20, 22 is placed on a platen 24 where dye-type ink such as acid dye, reactive dye, and substantive dye or pigment-type ink containing organic solvent such as solvent ink is ejected from an inkjet head 26 onto a surface of the medium 50.

The medium 50 on which the ink was deposited is introduced into a wave guide body portion 106 through a medium introduction portion 108 of the wave guide 100. Inside the wave guide body portion 106, electromagnetic waves are supplied from the magnetron 150. The electromagnetic waves supplied by the magnetron 150 are microwaves having a wavelength of from 100 μm to 1 m and a frequency of from 300 MHz to 3 THz, preferably, a wavelength of from 0.075 m to 0.15 m and a frequency of from 2 GHz to 4 GHz. In the wave guide body portion 106 into which electromagnetic waves are supplied, the ink deposited on the medium 50 is dried. The medium 50 entered into the wave guide body portion 106 is led out of the wave guide body portion 106 through a medium exit portion 110.

Just below the medium exit portion 110, a water-content detection sensor 62 for detecting a water content of the medium 50, a temperature detection sensor 64 for detecting the temperature of the medium 50, and a humidity detection sensor 66 for detecting the humidity of atmosphere around the medium 50 are arranged.

For example, the water-content detection sensor 62 may be of a capacitance type which detects the water content of the medium 50 by detecting a change in water vapor pressure around the medium 50 as a variation in impedance of the sensor. In addition, the water-content detection sensor 62 may be of a laser type which detects the water content of the medium 50 by irradiating the medium 50 with laser beams and employing a spectroscopic absorption technique using interaction between laser beam and matter. Alternatively, the water-content detection sensor 62 may be of a cooled mirror type which directly measures a dew point or a frost point by accurately measuring a temperature of a mirror surface using a high-precision temperature sensor. As water condenses into water or frost on the mirror surface, light emitted from a luminescent device is scattered on the mirror surface, with a result that the light intensity of a light-receiving detector is reduced. The temperature is controlled to maintain the condensation rate/evaporation rate of water molecule on the mirror surface constant. The water-content detection sensor 62 of the cooled mirror type defines the temperature at this point as the dew point or the frost point.

As the temperature detection sensor 64, a radiation thermometer of non-contact type may be preferably employed. For example, a radiation thermometer of a fever type utilizing thermal changes of a sensor element subjected to infrared ray radiation or a radiation thermometer of a quantum type utilizing changes of a sensor element subjected to light photon of infrared ray radiation may be employed. The humidity detection sensor 66 may be either of a type detecting relative humidity relative to the atmosphere around the medium 50 and a type detecting absolute humidity.

Detected values of the water-content detection sensor 62, the temperature detection sensor 64, and the humidity detection sensor 66 are outputted to a controller 40. The feeding speed of the medium 50 by the rollers 20, 22 is outputted from the roller driving unit 30 to the controller 40. Further, a target water content of the medium 50, a target temperature of the medium 50, or a target humidity of the atmosphere around the medium 50 after being printed is inputted via the operation input section 18. As will be described later, the controller 40 controls the intensity of electromagnetic waves from the magnetron 150 according to these parameters relating to a degree of the dryness (hereinafter referred to as “dryness”).

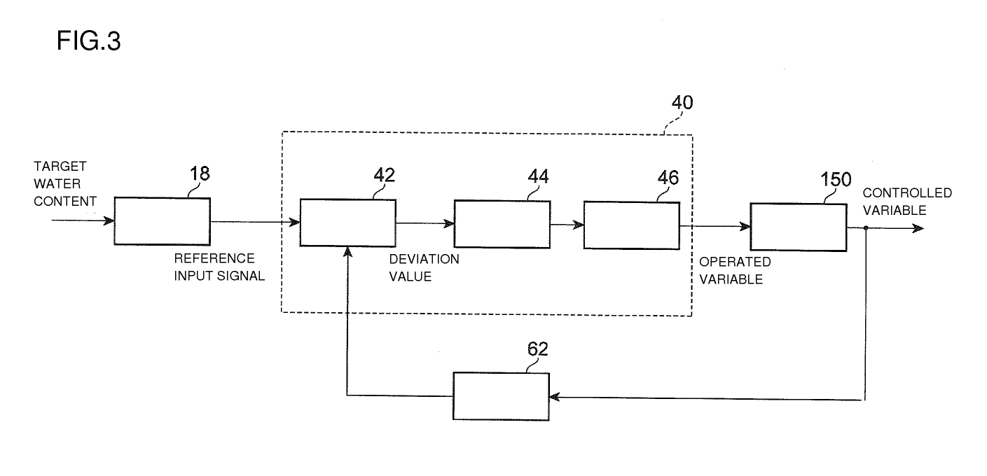

FIG. 3 is a block diagram showing a control system in the inkjet printer according to an embodiment. As shown in FIG. 3, in the inkjet printer 10 according to this embodiment, the intensity of electromagnetic waves supplied from the magnetron 150 is operated by a feedback control in which the intensity of the electromagnetic waves supplied from the magnetron 150 is calculated assuming that the water content of the medium 50 is a controlled variable, the intensity of the electromagnetic waves supplied by the magnetron 150 is an operated variable, and the water content of the medium 50 detected by the water-content detection sensor 62 is a feedback variable.

By the operation input section 18, a target water content of the medium 50 after being printed is inputted. The operation input section 18 converts the target water content into a reference input signal which is comparable to a detection signal from the water-content detection sensor 62 and outputs the reference input signal to the controller 40.

The controller 40 has a comparison section 42, an adjustment section 44, and a magnetron control section 46. The comparison section 42 compares the reference input signal from the operation input section 18 to the detection signal from the water-content detection sensor 62 so as to obtain a deviation value therebetween. The deviation value between the reference input signal and the detection signal is outputted to the adjustment section 44. The adjustment section 44 adjusts the deviation value between the reference input signal and the detection signal according to a control gain as a response characteristic satisfying the demand.

The magnetron control section 46 outputs the operated variable for operating the intensity of the electromagnetic waves to be supplied from the magnetron 150 according to the signal from the adjustment section 44. The water content of the medium 50 according to the intensity of the electromagnetic waves supplied from the magnetron 150 is detected by the water-content detection sensor 62. The water content of the medium 50 detected by the water-content detection sensor 62 is outputted as the feedback variable to the comparison section 42.

Since this embodiment includes the inkjet head 26 which ejects ink onto the medium 50 and the wave guide 100 which is structured to allow the medium 50 on which the ink is deposited by the inkjet head 26 to pass through the inside thereof, and the magnetron 150 which supplies electromagnetic waves into the wave guide 100, the electromagnetic waves supplied to the wave guide 100 enable effective drying of the medium 50 after being printed by uninterrupted processes.

According to this embodiment, the controller 40 controls the intensity of the electromagnetic waves supplied from the magnetron 150 according to the water content of the medium 50 detected by the water-content detection sensor 62 or the like, thereby enabling control of equalizing the dryness of the medium 50.

According to this embodiment, especially, the controller 40 operates the intensity of the electromagnetic waves supplied from the magnetron 150 by the feedback control in which the intensity of the electromagnetic waves supplied from the magnetron 150 is calculated assuming that the water content of the medium 50 is a controlled variable, the intensity of the electromagnetic waves supplied by the magnetron 150 is an operated variable, and the water content of the medium 50 detected by the water-content detection sensor 62 is a feedback variable, thereby enabling control of further equalizing the dryness of the medium 50.

Moreover in this embodiment, the controller 40 controls the dryness of the medium 50 to reach uniformity according to the water content of the medium 50 which is a parameter most directly relating to the dryness of the medium 50, thereby enabling control of still further equalizing the dryness of the medium 50.

The inkjet printer 10 of this embodiment can print on a sheet-like medium 50 made of paper, silk, cotton, vinyl chloride or the like with dye-type ink such as acid dye, reactive dye, and substantive dye or pigment-type ink containing organic solvent such as solvent ink, and uninterruptedly dry the medium 50.

In case of using aqueous ink or solvent ink relative to the sheet-like medium made of paper, silk, cotton, vinyl chloride or the like, acid dye or reactive dye as dye-type ink infiltrates into fibers of the medium 50 and reacts in the fibers, thereby staining the medium 50. Therefore, the reaction of the ink in the fibers of the medium 50 is promoted by electromagnetic waves supplied to the medium 50 through the wave guide 100 like the aforementioned embodiment, thereby improving the drying speed.

Solvent ink as pigment-type ink of an organic solvent type contains a resin therein so that the surface of the medium 50 is stained by the resin. Therefore, the drying of the water contained in the resin of the solvent ink is promoted by electromagnetic waves supplied to the medium 50 through the wave guide 100, thereby improving the drying speed.

On the other hand, substantive dye as a dye-type ink does not infiltrate into fibers of the medium 50 and stains the medium 50 just by that the ink is deposited on the surface of the medium 50. However, even in case of the substantive dye, if a resin is contained in the ink, the drying of water in the resin is promoted. Accordingly, like the aforementioned embodiment, the drying speed is improved by supplying electromagnetic waves to the medium 50 through the wave guide 100.

According to the embodiment of an inkjet printer or a printing method of the present invention, it is possible to further uniformly dry a medium.

Obviously, numerous modifications and variations of the present invention are possible in light of the above teachings. It is therefore to be understood that within the scope of the appended claims, the invention may be practiced otherwise than as specifically described herein. For example, though the example in which the water content of the medium 50 is assumed as the controlled variable has been mainly described in the embodiments, the present invention is not limited thereto and the temperature of the medium 50 or the humidity of atmosphere around the medium 50 may be assumed as the controlled variable. If the temperature of the medium 50 or the humidity of atmosphere around the medium 50 is assumed as the controlled variable, a device for detecting the temperature and the humidity can be structured simply because the temperature and the humidity are parameters which can be relatively easily detected.

Alternatively, if a feed forward control according to changes in the feeding speed of the medium 50 from the roller driving section 30 is also employed, delay in response of the intensity of the electromagnetic waves of the magnetron 150 to changes in the feeding speed of the medium 50 can be reduced.

What is claimed as new and desired to be secured by Letters Patent of the united states is:

1. An inkjet printer comprising:
an inkjet head configured to eject an ink onto a surface of a recording medium;
a wave guide through which the recording medium onto which the ink has been ejected is to pass;
an electromagnetic-wave supplier configured to supply electromagnetic waves into the wave guide;
a detector configured to detect a parameter relating to a dryness of the recording medium which has passed through the wave guide; and
a controller configured to control the electromagnetic-wave supplier to control an intensity of the electromagnetic waves according to the parameter relating to the dryness of the recording medium.

2. The inkjet printer as claimed in claim 1, wherein the controller is configured to perform a feedback control using the intensity of the electromagnetic waves to be supplied from the electromagnetic-wave supplier as an operated variable and the parameter relating to the dryness of the recording medium as a controlled variable and a feedback variable.

3. The inkjet printer as claimed in claim 1, wherein the parameter relating to the dryness of the recording medium is a speed of the recording medium which has passed through an inside of the wave guide.

4. The inkjet printer as claimed in claim 1, wherein the parameter relating to the dryness of the recording medium is a water content of the recording medium which has passed through an inside of the wave guide.

5. The inkjet printer as claimed in claim 1, wherein the parameter relating to the dryness of the recording medium is a temperature of the recording medium which has passed through an inside of the wave guide.

6. The inkjet printer as claimed in claim 1, wherein the parameter relating to the dryness of the recording medium is a humidity of atmosphere around the recording medium which has passed through an inside of the wave guide.

7. The inkjet printer as claimed in claim 2, wherein the parameter relating to the dryness of the recording medium is a water content of the recording medium which has passed through an inside of the wave guide.

8. The inkjet printer as claimed in claim 2, wherein the parameter relating to the dryness of the recording medium is a temperature of the recording medium which has passed through an inside of the wave guide.

9. The inkjet printer as claimed in claim 2, wherein the parameter relating to the dryness of the recording medium is the humidity of an atmosphere around the recording medium which has passed through an inside of the wave guide.

10. An ink dryer for an inkjet printer, the ink dryer comprising:
a wave guide through which a recording medium onto which an ink has been ejected is to pass;
an electromagnetic-wave supplier configured to supply electromagnetic waves into the wave guide;
a detector configured to detect a parameter relating to a dryness of the recording medium which has passed through the wave guide; and
a controller configured to control the electromagnetic-wave supplier to control an intensity of the electromagnetic waves according to the parameter relating to the dryness of the recording medium.

11. A printing method comprising:
ejecting an ink onto a surface of a recording medium;
supplying electromagnetic waves into a wave guide;
feeding the recording medium on which the ink has been ejected into the wave guide;
detecting a parameter relating to a dryness of the recording medium which has passed through an inside of the wave guide; and
controlling an intensity of the electromagnetic waves supplied from the electromagnetic-wave supplier according to the parameter relating to the dryness of the recording medium.
